(19) United States
(12) Patent Application Publication
(10) Pub. No.: US 2006/0174226 A1
(43) Pub. Date: Aug. 3, 2006

(54) Methods, Test Systems And Computer-Readable Medium For Dynamically Modifying Flow Of Executable Code

(75) Inventors: Donald T. Fair, Reston, VA (US); Michael R. Nordfelt, Centerville, VA (US)

Correspondence Address: MARTIN & HENSON, P.C., 9250 W 5TH AVENUE, SUITE 200, LAKEWOOD, CO, 80226, US

(73) Assignee: SYTEX, INC., Doylestown, PA (US)

(21) Appl. No.: 10/906,117

(22) Filed: Feb. 3, 2005

(51) Int. Cl. G06F 9/44

(52) U.S. Cl. 717/127

(57) ABSTRACT

Methods, test systems and computer-readable media are provided each relating to the collection of runtime data during code execution. This is accomplished without the need to reload the executable from its stored media image. The executable is instead altered while in memory, allowing program flow to be dynamically diverted without having to recompile the program, effect its binary, halt its execution, restart the program or otherwise change its fundamental behavior.

### BACKGROUND OF THE INVENTION

The present invention broadly relates to the field of computer programming, and more particularly concerns dynamically modifying flow of executable code paths in order to collect runtime data that is characteristic of a target program's behavior.

Software programs are essentially a set of machine instructions that are bundled in a specific order to perform a particular task when executed, with application software and system software being the two predominant software categories. Each time a program is executed on a computer, it is allocated space in memory where it is loaded by the operating system from a suitable storage medium, such as a disk. Areas in memory are also created for data storage, as well as the stack and heap. When the program is finished executing, it is unloaded from memory. During program execution, it is the copy in memory that is accessed by the operating system, unless the program is swapped out.

Generally speaking, software programs run (i.e. execute) by having their machine instructions sequentially executed. An exceptions to this is pipeline processing and other out of order executions. As known, in programming, sequences of instructions can be arranged into self-contained software routines, referred to as functions. Functions allow for code reuse as they can be called by different parts of a program, or even other programs. Once called by a calling instruction, the function performs its operation and thereafter returns control to the next instruction or to the calling program. In programming parlance, the terms “function”, “subroutine”, “procedure” and “module” are sometimes used interchangeably.

Oftentimes, modern software does not simply run from entry point to conclusion, but can assume a variety of different executable flows or paths depending on factors such as user input, results of calculations, or other unpredictable circumstances. While it is not always possible to know the code path a program will take, some insight can be gained by understanding the hierarchy and interdependencies of functions within a program. This can be determined in a variety of ways such as by analyzing the programming instructions (i.e. visually or otherwise), such as through a suitable dis-assembler, through reverse engineering a lower level version of the source code, or through known tools which generate call graphs based on the source code, to name a few.

Patching can be used to affect a program's flow. The term “patch” has various connotations, each relating to program alteration. For example, the term is sometimes used in the context of a program alteration which takes the form of a new executable module which replaces an old one. Patching can also refer to the changing of machine code when recompiling the source program is neither suitable nor convenient. These types of patches are static in nature. Another type of patching, referred to as “in memory patching” for distinction, dynamically patches software as it is executing in memory only. Accordingly, while the running programming code is patched the binary remains untouched. However, as soon as the software is reloaded from the storage medium all previous changes are gone. While such modifications have only a temporal effect this can be very useful when one desires to make such changes without damaging the actual binary. Non-destructive modifications of this type can be especially important when working with core components of an operating system since changes, generally, need only be temporary.

Programmers will appreciate that it is often desirable to assess certain aspects of a program's structure for a variety of different purposes including software monitoring, debugging, profiling and statistical analysis. Debuggers, for example, are software tools which assist programmers in locating errors in programming logic instructions by halting the program at certain break points and displaying information to the programmer. Thus, the programmer can proceed stepwise through the source code statements during execution of their corresponding machine instructions. While various types of analytical tools such as debuggers are quite useful as part of a programmer's repertoire, there remains a need to collect runtime data associated with program execution in a manner which does not necessitate recompiling the program, affecting it's binary, or halting its execution. This can be useful, for example, to gain additional insight into the characteristics of a program's execution not offered by known approaches. In particular, dynamic modification of code paths can reveal certain realtime characteristics of functions within a program so that runtime data associated with the functions can be collected, a capability not believed to be addressed in known techniques.

### BRIEF SUMMARY OF THE INVENTION

Methods, test systems and computer-readable media are provided each relating to the collection of runtime data during code execution. The described embodiments of the present invention are implemented on an x86-based computer system architecture, with the target program being a Linux operating system (OS) kernel and each parent function being a system call associated with kernel.

In one exemplary embodiment of the method, flow of a target program having associated executable code is dynamically modified so that the runtime data can be collected. Here, the target program is run in computer memory and its executable code is searched at runtime to locate a reference therein to a target function. Upon detecting the reference, at least a portion of the target program's executable code is patched whereby program flow is directed, upon subsequent reference to the target function, to a replacement function. The replacement function is operative to collect runtime data associated with the target function and thereafter return control to the target function to allow for continued execution of the target program.

The program's source code is preferably scanned (e.g. visually) prior to runtime to identify the target function, and the method may also comprise coding the replacement function. To this end, the replacement function may be coded as a wrapper function which incorporates a reference to the target function and is of the same prototype as the target function so that it accepts and returns the same parameters. In addition, each reference which is detected may be a programming instruction which corresponds to a call to the target function, a jump the target function, or any other redirection of program flow to the target function. Advantageously also, the runtime data which is collected may be statistical information indicative of a number of times the target function is referenced during execution of the target program, or other suitable information which can be collected to obtain gain insight into the behavior of at least a portion of the target program. By way of illustration, such information could relate systems calls activity, system scheduler activity, or memory management activity, to name only a few representative examples.

Another exemplary embodiment comprises the preliminarily identifying the target program, as well as a target function with the target program and each parent function which references target function. Here also, a replacement function is coded to include replacement function code for collecting the runtime data and for referencing the target function. Then, during execution of the target program, the executable code associated with each parent function which has been identified is searched to locate each reference pointing to the target function. In the described embodiments, the executable code is searched by sequentially scanning bytes of data within the parent function's memory address space to locate each reference therein to the target function. Each located reference is directed to point instead to the replacement function, whereupon continued execution of the target program enables collection of the runtime data.

Test systems are also provided for collecting runtime statistical data. A test system comprises a storage device, or storage means, for storing a target program in memory. A processor, or processing means, is programmed for running the target program, searching the target program's executable code at runtime to locate each reference therein to a target function, and patching at least a portion of the target program's executable code upon detection of the reference whereby program flow is subsequently directed to a replacement function when the target function.

Finally, a computer-readable medium is provided for dynamically diverting flow of a target program's executable code in order to collect runtime statistical data which is characteristic of behavior of a target function within the program during execution. In a described embodiment, the runtime statistical data is indicative of a number of times the target function is referenced during program execution. The computer-readable medium comprises a loadable kernel module (LKM) having executable instruction for performing a method which, during execution in computer memory of the target program, comprises patching each reference to the target function so that program flow is directed to a replacement function which collects the runtime statistical data, while not interfering with continued operation of the target program.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 diagrammatically represents a method of dynamically modifying flow of a target program according to a first exemplary embodiment of the present invention;

FIG. 2 is diagrammatically represents a method of dynamically diverting flow of a target program according to a second exemplary embodiment of the present invention;

FIG. 3 diagrammatically depicts a function hierarchy by illustrating various interdependencies amongst functions associated with a representative target program;

FIG. 4 represents a high level flowchart for computer software which implements functionalities associated with various embodiments of the present invention;

FIG. 5 is a more detailed high level flowchart for computer software which implements functionalities associated with the various embodiments of the present invention;

FIG. 6a is a representative, diagrammatic view illustrating code flow characteristics when concepts of the present invention are applied to system call related functions within a Linux kernel;

FIG. 6b is similar to FIG. 6a, but showing alternative code flow characteristics; and

FIG. 7 shows a diagram of an exemplary general purpose computer system that may be configured to implement aspects of the test system of the present invention.

### DETAILED DESCRIPTION OF THE INVENTION

The present invention provides for the modification of code paths during software execution, thereby allowing running executables to be altered so that runtime data can be collected. This is accomplished without the need to reload the executable from its stored media image. The executable is instead altered while in memory, allowing program flow to be dynamically diverted without having to recompile the program, effect its binary, halt its execution, restart the program or otherwise change its fundamental behavior. This can be particularly helpful in analyzing code which resides in an operating system's (OS) kernel, since the kernel cannot be stopped and restarted without rebooting the computer system. The artisan will appreciate that, if desired or necessary, any code path modifications can also be dynamically reversed. The described implementation of the present invention patches aspects of an OS kernel so that a user can examine behavior without needing to reboot the computer. However, the ordinarily skilled artisan will recognize that the principal concepts of the present invention can be extended to examine any executable running on a system, whether in user space or kernel space, and is believed to be particularly useful for examining a machine's critical services such as systems calls activity, system scheduler activity, or memory management activity.

Since changes are only temporal and last for that instance of the executable, reloading the program from media (e.g. a disk) will cause them to be lost. However, modifying the code path such as by dynamically diverting its flow can have many different useful applications including software monitoring, debugging, profiling and statistical analysis. For example, the executable's runtime calls can be logged and examined to determine the frequency of selected calls. Existing approaches which are generally known to the inventors require that a process be stopped, that the program on media be patched in order to insert data generation functionality, and that the process then be restarted in order to begin data collection.

In the following detailed description, reference is made to the accompanying drawings which form a part hereof, and in which is shown by way of illustrations specific embodiments for practicing the invention. The leading digit(s) of the reference numbers in the figures usually correlate to the figure number; one notable exception is that identical components which appear in multiple figures are identified by the same reference numbers. The embodiments illustrated by the figures are described in sufficient detail to enable those skilled in the art to practice the invention, and it is to be understood that other embodiments may be utilized and changes may be made without departing from the spirit and scope of the present invention. The following detailed description is, therefore, not to be taken in a limiting sense, and the scope of the present invention is defined by the appended claims.

Various terms are used throughout the description and the claims which should have conventional meanings to those with a pertinent understanding of computer programming in general, and more particularly assembly code and machine code. Other terms will perhaps be more familiar to those conversant in the areas of computer architecture and operating system (OS) kernels. While the description to follow may entail terminology which is perhaps tailored to certain operating system platforms or programming environments, the ordinarily skilled artisan will appreciate that such terminology is employed in a descriptive sense and not a limiting sense.

Source code for software which implements aspects of the invention has been developed in the C programming language on an x86 machine running the Red Hat Linux 7.3 OS, with GCC as the compiler. An explanation of the Linux operating system is beyond the scope of this document and the reader is assumed to be either conversant with its kernel architecture or to have access to conventional textbooks on the subject, such as Linux Kernel Programming, by M. Beck, H. Böhme, M. Dziadzka, U. Kunitz, R. Magnus, C. Schröter, and D. Verworner., 3^{rd} ed., Addison-Wesley (2002). It is believed, however, that software embodying aspects of the invention could readily be ported to other types of Intel-based OS platforms, as well as other types of chip sets. Further, the programming could be developed using several widely available programming languages with the software component(s) coded as subroutines, sub-systems, or objects depending on the language chosen. In addition, various low-level languages or assembly languages could be used to provide the syntax for organizing the programming instructions so that they are executable in accordance with the description to follow. Thus, the preferred development tools utilized should not be interpreted to limit the environment of the present invention.

Software embodying the present invention may be distributed in known manners, such as on computer-readable medium which contains the executable instructions for performing the methodologies discussed herein. Alternatively, the software may be distributed over an appropriate communications interface so that it can be installed on the user's computer system. Furthermore, alternate embodiments which implement the invention in hardware, firmware or a combination of both hardware and firmware, as well as distributing the modules and/or the data in a different fashion will be apparent to those skilled in the art. It should, thus, be understood that the description to follow is intended to be illustrative and not restrictive, and that many other embodiments will be apparent to those of skill in the art upon reviewing the description.

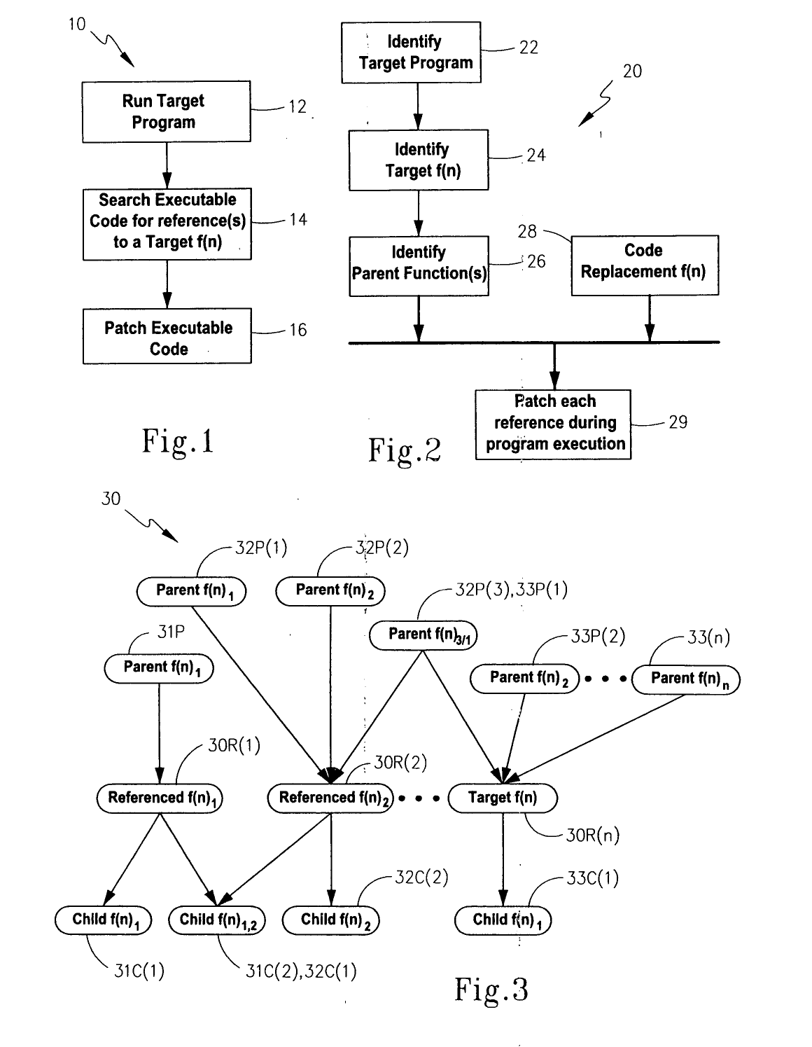

A first exemplary embodiment 10 of a method of dynamically diverting flow of a target program is described with initial reference to FIG. 1. The target program is run in computer memory at 12 and its executable code is searched during runtime at 14 to locate a reference(s) therein to a target function. At least a portion of the target program's executable code is patched at 16 whereby program flow is directed, upon subsequent reference to the target function, to a replacement function. The replacement function is operative to collect runtime data associated with the target function and it thereafter returns control to the target function to allow for continued program execution. As a representative example of the runtime data which can be collected, statistical information can be gather which is indicative of a number of times the target function is referenced during execution of the target program. The particular code for collecting the runtime data, whether it be statistical data or other type(s) of information, would be up to the programmer.

A second exemplary embodiment of a method 20 is shown in FIG. 2 and contemplates the preliminary steps of initially identifying the target program at 22, a target function associated with the target program at 24, and each parent function which references the target function at 26. Also entailed in method 20 is the coding of the replacement function 28 for collecting the runtime data and for referencing the target function. Once accomplished, each identified reference is patched 29 during the target program's execution. Preferably for each parent function that has been identified: (1) its executable code is searched to locate each reference therein which points to the target function, and (2) each reference is directed to point instead to the replacement function whereupon continued execution of the target program enables collection of the runtime data.

In identifying the parent function(s) which reference a target function of interest, it can help to have a sufficient understanding of the target program's structural organization. One way to achieve this is to scan code associated with the target program, such as the source code itself or an intermediate or lower level version of the source code, e.g., assembly code, machine code, etc. Scanning can be done visually to obtain an understanding of functional hierarchy and interdependency, or by other means as discussed in the background section. Thus, the particular manner in which interdependencies are obtained is less important than understanding the interdependencies themselves.

FIG. 3 illustrates a representative functional hierarchy 30 associated with a target program. As shown, the target program has a plurality of functions which are each referenced by one or more parent functions. Such functional references can be calls, jumps, passing of one or more addresses as a parameter, or any other means of redirecting execution. Thus, it may be seen that there are a plurality of referenced functions 30R(1), 30R(2) . . . 30R(n) within hierarchy 30. Each of these referenced functions has one or more parent and child functions associated with it. The terms “parent” and “child” are used simply to distinguish between those functions which, in the exemplary embodiment, call a referenced function from those which are called by a referenced function. Thus, it can be appreciated from FIG. 3 that each depicted referenced function can also be considered a child of each parent function which calls it. For example, referenced function 30R(1) has a single parent function 31P which calls it and two child functions 31C(1) and (2) called by it. Similarly, referenced function 30R(2) has three parent functions 32P(1)-(3) which call it and one child function 32C referenced buy it. As also shown, one or more referenced function can be called by a given parent function and a given child function can be called by one or more referenced functions.

One of the referenced functions within the target program, namely referenced function 30R(n), is referred to herein as the “target function” or “target f(n)” since it is one which is to be patched. It may be seen for representative purposes in FIG. 3 that target function 30R(n) has any number of parent functions 33P(1)-(n) which reference it, and it calls a single child function 33(C). It is the parent functions 33P(1)-(n) which are of interest to the present invention and not necessarily child function 33(C). However, an multiple level functional hierarchy representatively depicted in FIG. 3 to provide a context for describing pertinent aspects of the present invention.

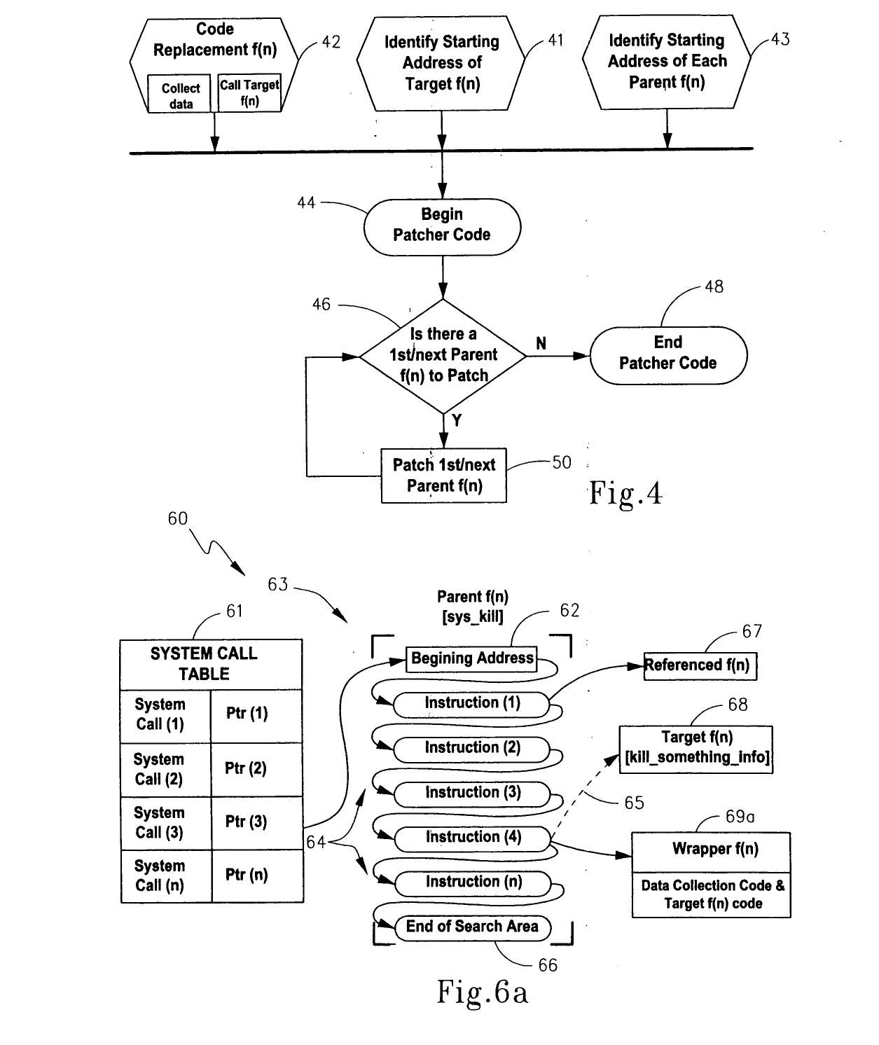

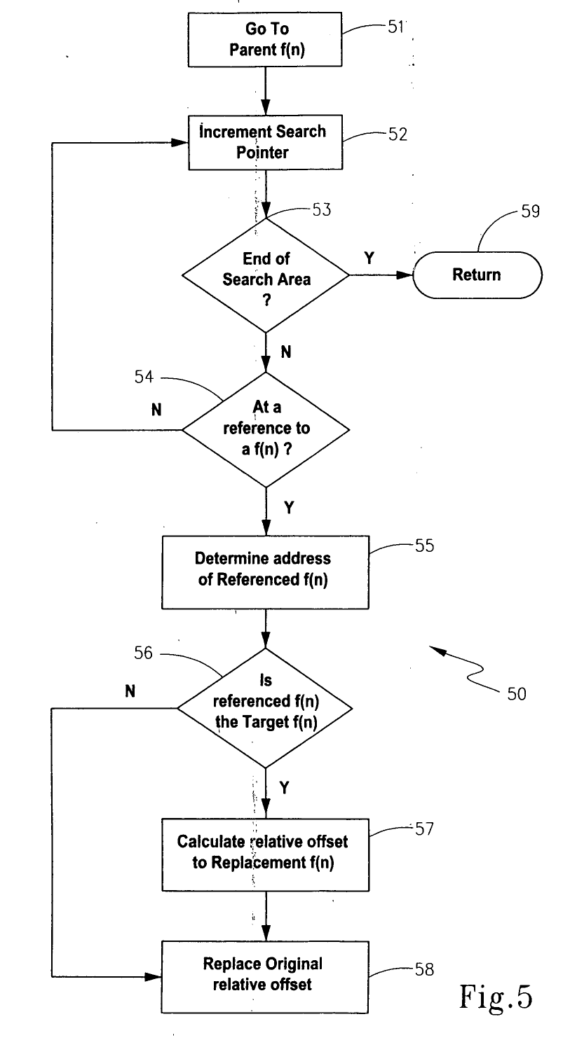

Obtaining a suitable functional hierarchy can be helpful in identifying which function(s) are to be monitored as the target function(s), if not already known. In any event, once a target function and each of its referencing parent functions have been identified additional information can be obtained. For example, as shown in FIG. 4, once the target function has been identified its starting address in memory is obtained at 41 through known approaches, as will be described below with reference to FIGS. 5 & 6. Likewise, the starting address of each parent function can be obtained 42. It is contemplated that, in some instances, not all of the parent function references will need be patched, and it may be advantageous to only look at a selected subset.

Another prerequisite is to have access to a replacement function which can be either coded by the user or obtained from another source. That is, in FIG. 4 a replacement function is coded at 43. In the preferred embodiment, the replacement function is actually a wrapper function which incorporates a reference to the target function and is of the same prototype as the target function such that it accepts and returns the same parameters. Thus, if the original target function has the prototype “int old_function(int arg1, int arg2)”, then the replacement “wrapper” function will have the prototype “int new_function(int arg1, int arg2)”. Inside the wrapper function there will be code for collecting the runtime data and for calling the original target function. This will allow the target program's executable to continue functioning as originally intended and keep track of what the original function returns, while also enabling the collection of desired runtime data for analytical purposes.

Once prerequisites 41-43 have been achieved in any suitable order, the patcher code begins at 44 whereupon and makes a determination at 46 as to whether there is a 1st/next parent function to patch. Under normal operation, the response to this initial inquiry is in the affirmative and the flow proceeds at 50 (see also FIG. 5) to patch the first parent function. This process is repeated with respect to each parent function of interest until completion, at which point the patcher code ends at 48.

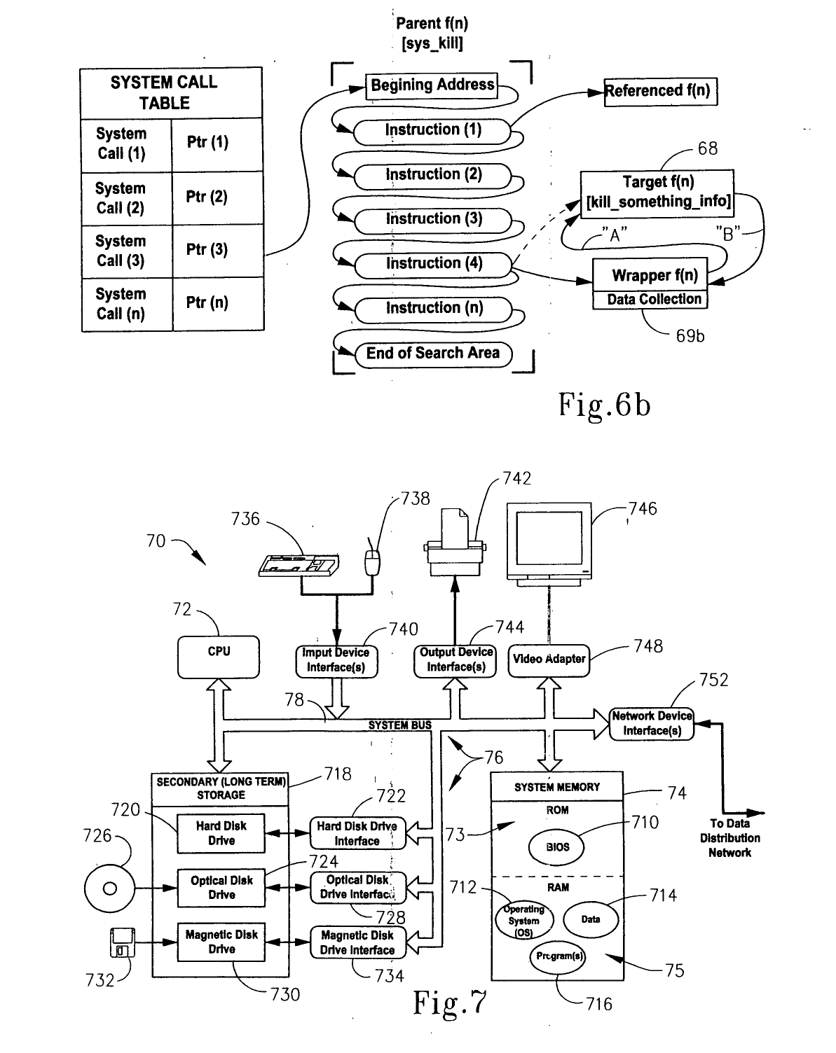

Reference will now made to FIGS. 5, 6a and 6b to describe two possible implementations of the invention. For this purpose, assume it is desirable to monitor the function “kill_something_info” associated with the Linux kernel. This function thus becomes the target function. In memory patching of the kill_something_info target function is accomplished by re-writing call instructions so they point at and effectively “call” a new wrapper function. Thus, assuming it is desirable to monitor the input and output parameters of function kill_something_info, a wrapper around the function can be coded to having the characteristics:

Wrapper(kill_something_info's parameters){

<analyze kill_something_info's parameters>
<call kill_something_info>
<analyze kill_something_info's returned value>
return kill_something_info's returned value
(this includes any parameters passed by reference)

}

A suitable knowledge of the Linux kernel's open source code would reveal that kill_something_info is referenced by at least one parent function, namely “sys_kill”, and a call to kill_something_info within sys_kill might appear in assembly code as:

0xc0120eb4 <sys_kill+68>: call 0xc01205b0 <kill_something_info>

With reference to the data flow diagram 60 of FIG. 6a, it can be appreciated that the parent function sys_kill is one of a variety of functions within the Linux kernel which are referenced, in this case pointed to, within the system call table 61. As those familiar with this field would understand, the beginning address 62 within the memory space 63 of parent function sys_kill can be obtained, for example, by resolving from the system.map file.

Once this information is obtained, patching routine 50 (FIG. 5) proceeds at 51 to go to the parent function sys_kill (i.e. its beginning address 62) and search executable code associated with the parent function, byte-by-byte, until an e8 notation is found. An e8 notation is a well known assembly opcode for an x86 Intel architecture call function, which represents one type of function reference, and this particular instruction is used to call functions in Linux kernels. In FIG. 6a it may seen for representative purposes that the parent function sys_kill has a plurality of instructions, generally 64, which occupy address space 63. For example, below is a representative excerpt from a dump of assembler code for the function sys_kill which might correspond to such instructions:

Dump of assembler code for function sys_kill:

0xc0120eb2 <sys_kill+66>: push %eax

0xc0120eb3 <sys_kill+67>: push %ecx

0xc0120eb4 <sys_kill+68>: call 0xc01205b0 <kill_something_info>

0xc0120eb9 <sys_kill+73>: add $0x8c,%esp

0xc0120ebf <sys_kill+79>: pop %ebx

The artisan with a suitable understanding of assembly code would recognize that programming instructions can be developed to dynamically scan assembly code at runtime to identify the call to kill_something_info at location 0xc0120eb4. In FIG. 6a, this might correspond for example to the referencing at 65 of the target function 66 following instruction (3). In the flowchart of FIG. 5, it can be appreciated that once the search pointer is initially incremented at 52, and presuming at 53 that the parent function's end of search area 66 has not been reached, determinations will be made with respect to each encountered instruction (1)-(n) as to whether this a reference to a function. For example, in FIG. 6a it may be seen that instruction (1) references a function 67. The address of the referenced function 67 will be determined at 55 and an assessment made at 56 as to whether the referenced function is the target function, not the case here. It can be appreciated with reference to the example in FIG. 6a that the search pointer will sequentially be incremented until instruction (3) is encountered, at which point the response to inquiry 56 in FIG. 5 is in the affirmative. Referring again to the assembler code dump above, a reference to the target function is encountered by the line:

0xc0120eb4 <sys_kill+68>: call 0xc01205b0 <kill_something_info>

Using gdb, the memory at 0xc012eb4 (the call to kill_something_info) will look like:

(gdb) x/4 0xc0120eb4

0xc0120eb4 <sys_kill+68>: 0xfff6f7e8 0x8cc481ff 0x5b000000

Having identified the e8 opcode above, the next four bytes (in this case fffff6f7) are used in calculating the relative offset of where to jump to. By convention, the call is offset relative to the current instruction pointer (in this case 0xc 0120eb9) which is the next instruction to execute. This might correspond for instance to instruction (4) in FIG. 6a. A relative offset to the replacement function is calculated at 57 in FIG. 5. This is done by adding the four bytes that follow the e8 opcode to the current instruction pointer. In doing so, the four bytes are treated as a signed integer value, meaning they can be of positive or negative signage. Continuing with the example, calculating the jump from the instruction pointer, which is 0xc0120eb9:
0xc0120eb9+fffff6f7=0xc01205b0

This yields the address of 0xc01205b0 which is the address of the target function 68. Since the starting address of the target function was previously identified, for example with reference to the prerequisite step 41 in FIG. 4, this verifies that the correct jump has been located.

Unlike previous functions, since the custom wrapper function has been created, pointer manipulation is used to learn its address. The following representative “C” source code demonstrates one method of determining this value where the funcPtr variable is assigned to hold the address of “new_kill_something_info” which is the wrapper function.

typedef int (*kill_something_info_t) (int, struct siginfo *, int)

kill_something_info_t funcPtr;

funcPtr=(kill_something_info_t)new_kill_something_info;

Continuing with the example, the replacement (i.e. wrapper) function 69a is located, per the above, at 0xca90a108, and the current instruction pointer is at 0xc0120eb9. A new relative offset can thus be calculated by subtracting the current instruction pointer from the wrapper function:
0xca90a108−0xc0120eb9=0xa7e9245

Once the new relative offset is calculated, it is copied into memory where the original offset was held, thus accomplishing operation 58 in FIG. 5. At this point, a code dump of sys_kill will yield:

0xc0120eb2 <sys_kill+66>: push %eax

0xc0120eb3 <sys_kill+67>: push %ecx

0xc0120eb4 <sys_kill+68>: call 0xca90a108

0xc0120eb9 <sys_kill+73>: add $0x8c,%esp

0xc0120ebf <sys_kill+79>: pop %ebx

Using gdb, the memory at kill_something_info will now look like:

(gdb) x/4 0xc0120eb4

0xc0120eb4 <sys_kill+68>: 0x7e924fe8 0x8cc4810a 0x5b000000

It can be appreciated, then, that the next time the parent function sys_kill is called, the wrapper function 69a located in memory now at 0xca90a108 will be called instead of the target function kill_something_info. As such, the code is patched and the analytical functions of the wrapper can be used to collect the appropriate runtime data. The parent function's memory address space 63 can further be searched and patched for as many areas and occurrences of the target function as is desired for the particular application. This capability is contemplated by the flowchart in FIG. 5.

In a preferred embodiment of the present invention, the wrapper function 69a is shown in FIG. 6a to include both the code for collecting the runtime data, as well as code for calling the target function. Thus, when the program's executable code is patched, the wrapper function 69a actually replaces the target function. As shown in FIG. 6b, however, it is contemplated instead that a replacement function 69b could also be coded to include the data collection code as well as an external call to the target function 68, as indicated by arrow “A” which then returns control to replacement function 69b as indicated by arrow “B”.

Having described some representative deployment and operating environments for practicing the invention, reference is now made to FIG. 7 which shows a representative configuration of a user computer for implementing aspects of the invention. User computer 70 is configured as a general purpose computer system 70, and the artisan should recognize that not all of the components which are depicted in FIG. 7 need be present to realize the capabilities afforded by the present invention. Thus, FIG. 7 is for representative purposes only.

With this in mind, computer system 70 includes a processing unit, such as CPU 72, a system memory 74 and an input output (I/O) system, generally 76. These various components are interconnected by system bus 78 which may be any of a variety of bus architectures. System memory 74 may include both non-volatile read only memory (ROM) 73 and volatile memory such as static or dynamic random access memory (RAM) 75. Programmable read only memories (PROMs), erasable programmable read only memories (EPROMs) or electronically erasable programmable read only memories (EEPROMs) may be provided. ROM portion 73 stores a basic input/output system (BIOS) 71 0. RAM portion 75 can store the operating system 71 2, data 71 4, and/or programs 71 6 such as the patcher code program described herein. Computer system 60 may be adapted to execute in any of the well-known operating system environments, such as Windows, UNIX, MAC-OS, OS2, PC-DOS, DOS, etc.

Various types of storage devices can be provided as more permanent data storage areas which can be either read from or written to, such as contemplated by secondary storage region 718. Such devices may, for example, include a permanent storage device in the form of a large-capacity hard disk drive 720 which is connected to the system bus 78 by a hard disk drive interface 722. An optical disk drive 724 for use with a removable optical disk 626 such as a CD-ROM, DVD-ROM or other optical media, may also be provided and interfaced to system bus 78 by an associated optical disk drive interface 728. Computer system 70 may also have one or more magnetic disk drives 730 for receiving removable storage such as a floppy disk or other magnetic media 732 which itself is connected to system bus 78 via magnetic disk drive interface 734. Remote storage over a network is also contemplated.

System 70 may be adapted to communicate with a data distribution network (e.g., LAN, WAN, the Internet, etc.) via communication link(s). Establishing the network communication is aided by one or more network device(s) interface(s) 752, such as a network interface card (NIC), a modem or the like which is suitably adapted for connection to the system bus 78. System 70 preferably also operates with various input and output devices. For example, user commands or other input data may be provided by a keyboard 736, a mouse 738 or other appropriate device which is connected to the processing unit 72 through an appropriate interface(s) 740 connected to system bus 78. System 70 is also adapted to receive one or more output devices, such as printer 742, coupled to the computer system bus 78 via an appropriate output device interface(s) 744. A monitor 746 or other suitable display device may also be connected to the system bus 78, for example, by a video adapter 748. A variety of input, output and display devices are available and any suitable one(s) which may be used or needed for effectuating the purposes of the invention are deemed to be encompassed.

One or more of the memory or storage regions mentioned above may comprise suitable media for storing programming code, data structures, computer-readable instructions or other data types for the computer system 70. Such information is then executable by processor 72 so that the computer system 70 can be configured to embody aspects of the present invention. Alternatively, the software may be distributed over an appropriate communications interface so that it can be installed on the user's computer system.

Although certain aspects of a computer system may be preferred in the illustrative embodiments, the present invention should not be unduly limited as to the type of computer on which it runs, and it should be readily understood that the present invention indeed contemplates use in conjunction with any appropriate information processing device having the capability of being configured in a manner for accommodating the invention. Moreover, it should be recognized that the invention could be adapted for use on computers other than general purpose computers, as well as on general purpose computers without conventional operating systems.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

What is claimed is:

1. A method of dynamically modifying flow of a target program, having associated executable code, so that runtime data can be collected, said method comprising:
a. running the target program in computer memory;
b. searching the target program's executable code at runtime to locate a reference therein to a target function;
c. patching at least a portion of the target program's executable code upon detection of said reference whereby program flow is directed, upon subsequent reference to the target function, to a replacement function which is operative to collect runtime data associated with the target function and thereafter return control to the target function to allow for continued execution of the target program.

2. A method according to claim 1 whereby said reference is a programming instruction which corresponds to a call to the target function.

3. A method according to claim 1 whereby said replacement function is coded as a wrapper function which incorporates a reference to the target function and is of the same prototype as the target function such that the wrapper function accepts and returns the same parameters as the target function.

4. A method according to claim 1 comprising coding said replacement function.

5. A method according to claim 1 whereby the runtime data is statistical information indicative of a number of times said target function is referenced during execution of the target program.

6. A method according to claim 1 comprising scanning source code associated with the target program prior to runtime to identify said target function.

7. A method of dynamically diverting flow of executable programming code in order to collect runtime data for analysis, comprising:
a. identifying a target program;
b. identifying a target function associated with the target program;
c. identifying each parent function which references the target function;
d. coding a replacement function which includes replacement function code for collecting the runtime data and for referencing the target function; and
e. during execution of the target program, and with respect to each parent function identified in (c):
(i) searching executable code associated with the parent function to locate each reference therein which points to the target function; and
(ii) directing each said reference to point instead to said replacement function, whereupon continued execution of the target program enables collection of the runtime data.

8. A method according to claim 7 implemented on an x86-based computer system architecture, whereby said target program is a LINUX OS kernel and each said parent function is a system call associated with the kernel.

9. A method according to claim 7 whereby the associated executable code for each identified parent function resides in a respective memory address space and whereby operation (e)(i) comprises sequentially searching bytes of data within the respective memory address space to locate each reference therein to the target function.

10. A method according to claim 9 whereby each said reference is selected from one of a call to the target function and a jump to the target function.

11. A method according to claim 10 whereby each said reference is a call to the target function.

12. A method according to claim 7 whereby identification of each said parent function which references the target function is accomplished by scanning source code associated with the target program.

13. A method according to claim 12 comprising visually scanning said source code.

14. A method according to claim 7 whereby said replacement function is coded as a wrapper function which incorporates a reference to the target function and is of the same prototype as the target function such that the wrapper function accepts and returns the same parameters as the target function.

15. A method according to claim 7 whereby said runtime data is statistical information indicative of a number of times said target function is referenced during execution of said target program.

16. A computer-readable medium for dynamically diverting flow of a target program's executable code in order to collect runtime statistical data which is characteristic of behavior of a target function within the program during execution, said computer-readable medium comprising a loadable kernel module (LKM) having executable instructions for performing a method which, during execution in computer memory of the target program, comprises patching each reference to the target function so that program flow is directed to a replacement function which collects the runtime statistical data, while not interfering with continued operation of the target program.

17. A method according to claim 16 whereby said replacement function is coded as a wrapper function which incorporates a reference to the target function and is of the same prototype as the target function such that the wrapper function accepts and returns the same parameters as the target function, and wherein said runtime statistical data is indicative of a number of times the target function within the program is being referenced during program execution.

18. A test system for collecting runtime statistical data, comprising:
a. a storage device for storing a target program in memory;
b. a processor programmed to:
(i) run the target program;
(ii) search the target program's executable code at runtime to locate each reference therein to a target function; and
(iii) patch at least a portion of the target program's executable code upon detection of said reference whereby program flow is directed, upon subsequent reference to the target function, to a replacement function which is operative to collect the runtime statistical data associated with the target function and thereafter return control to the target function to allow for continued execution of the target program; and
c. an output device for presenting the runtime statistical data.

19. A test system for collecting runtime statistical data, comprising:
a. storage means for storing a target program in memory;
b. processing means for:
(i) running the target program;
(ii) searching the target program's executable code at runtime to locate each reference therein to a target function; and
(iii) patching at least a portion of the target program's executable code upon detection of said reference whereby program flow is directed, upon subsequent reference to the target function, to a replacement function which is operative to collect the runtime statistical data associated with the target function and thereafter return control to the target function to allow for continued execution of the target program; and
c. output means for presenting the runtime statistical data.
